(19) United States
(12) Patent Application Publication
(10) Pub. No.: US 2003/0098568 A1
(43) Pub. Date: May 29, 2003

(54) Safety locking wheelchair

(76) Inventor: Elliot Fredrick Keppler, Indian Harbor Beach, FL (US)

Correspondence Address: Elliott P. Keppler, 419 Hawthorne Ct., Indian Harbor Beach, FL, 32937, US

(21) Appl. No.: 09/929,529

(22) Filed: Nov. 16, 2001

(51) Int. Cl. B62J 1/00

(52) U.S. Cl. 280/304.1

(57) ABSTRACT

The invention represents the disclosure of a novel automatically activated device that locks the wheels of a wheelchair, to prevent backward motion of the chair when the occupant arises, reducing the risk that the chair's occupant may fall due to the backward motion of the chair. The device is activated when the occupant leaves the seated position And the device is inactivated when the occupant resumes the seated position in the chair, allowing the wheels again to move freely. The device, which is designed to be installed upon existing wheelchairs, and newly manufactured wheelchairs, includes a disabling device, enabling free movement of the wheelchair when unoccupied.

1. The invention is a mechanism that automatically locks the wheels on a wheelchair that is used in hospitals and nursing homes and releases the wheels when a person sits in the wheelchair.

2. The invention is designed for patients who forget to lock the wheels of the wheelchair before getting up or sitting down.

3. The invention is designed so that while the patient is sitting in the chair, it is free-wheeling and movable, and when the patient wants to remove him or herself. It automatically unlocks the wheel by a spring mechanism when the person's weight is removed from the seat.

4. The invention prevents a person from falling because when the wheels are not locked, the wheelchair can rolls away from them.

5. Though drawings show a locking mechanism for wheelchairs, this can be modified for any wheelchair.

6. A Prototype was made and tested by nursing home nurses and attendants and they all believed that the invention would help to prevent patients from falling and breaking hips and damaging their head, arms, or legs.

7. The materials, hardware, and fasteners utilized in fabricating this invention can differ, depending on availability.

8. When patients forget to lock the brake and they place their hands on the armchair as they begin to stand up out of the chair, or when they push with their hands and arms to get out of the wheelchair, the chair rolls backward and they can fall and hurt themselves.

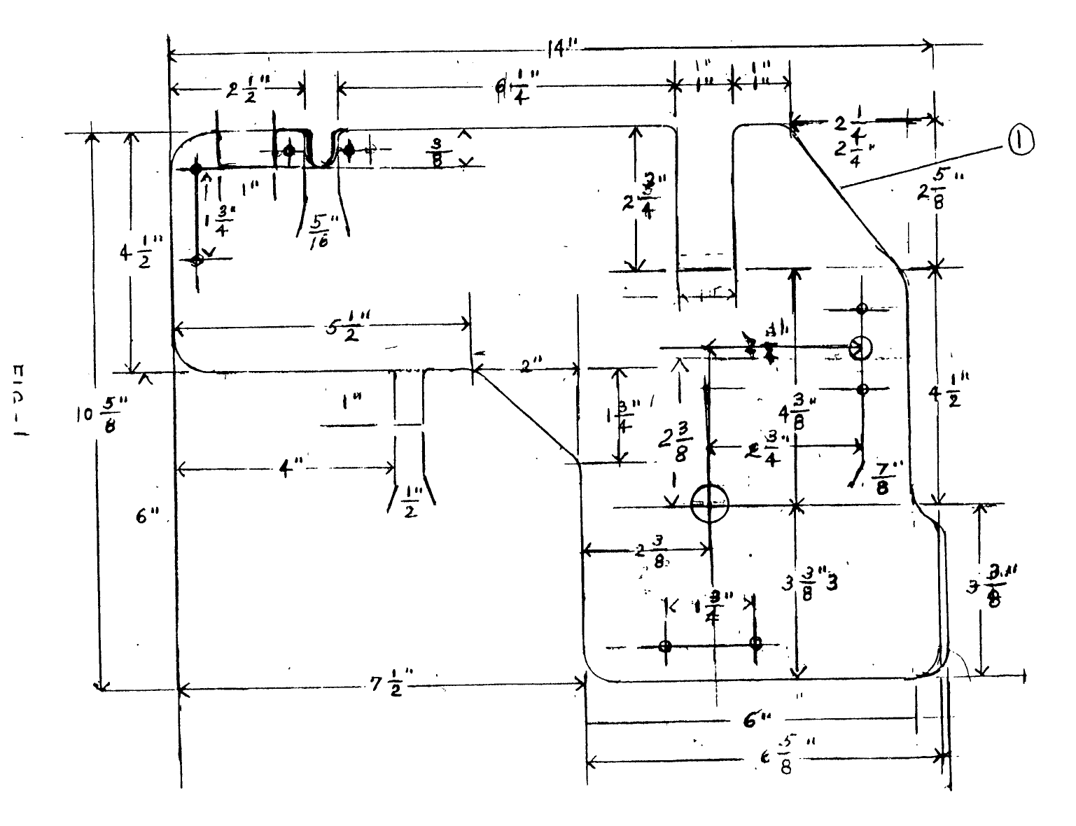

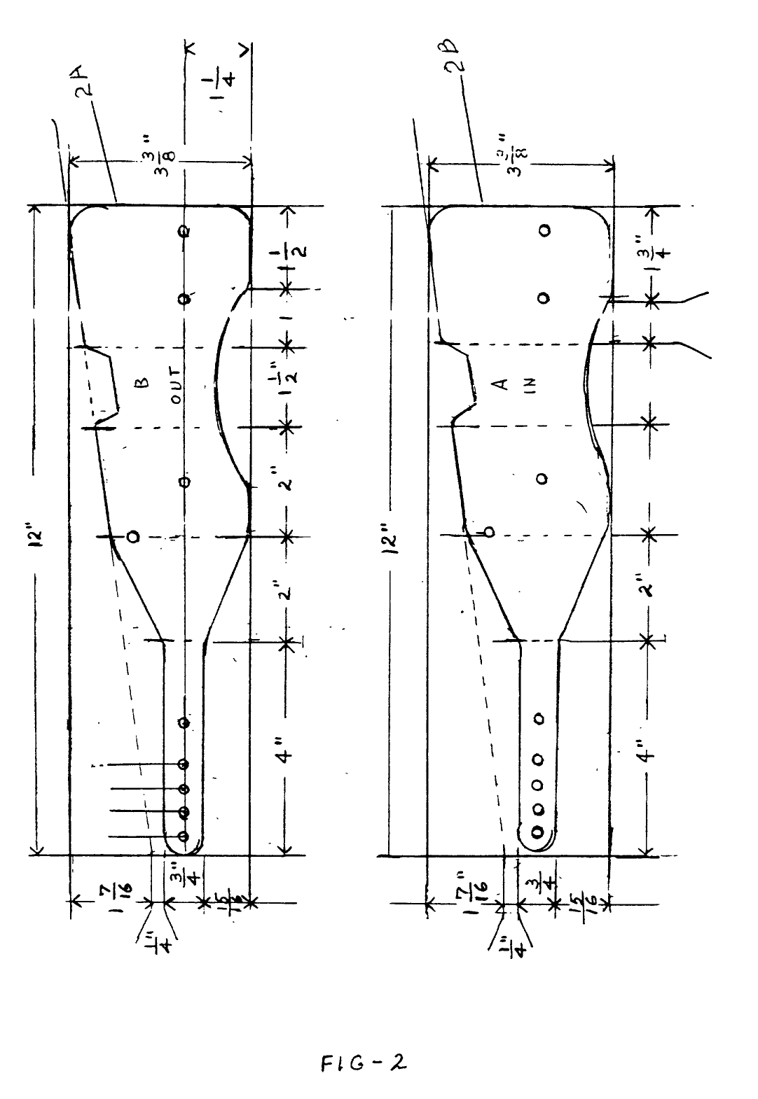

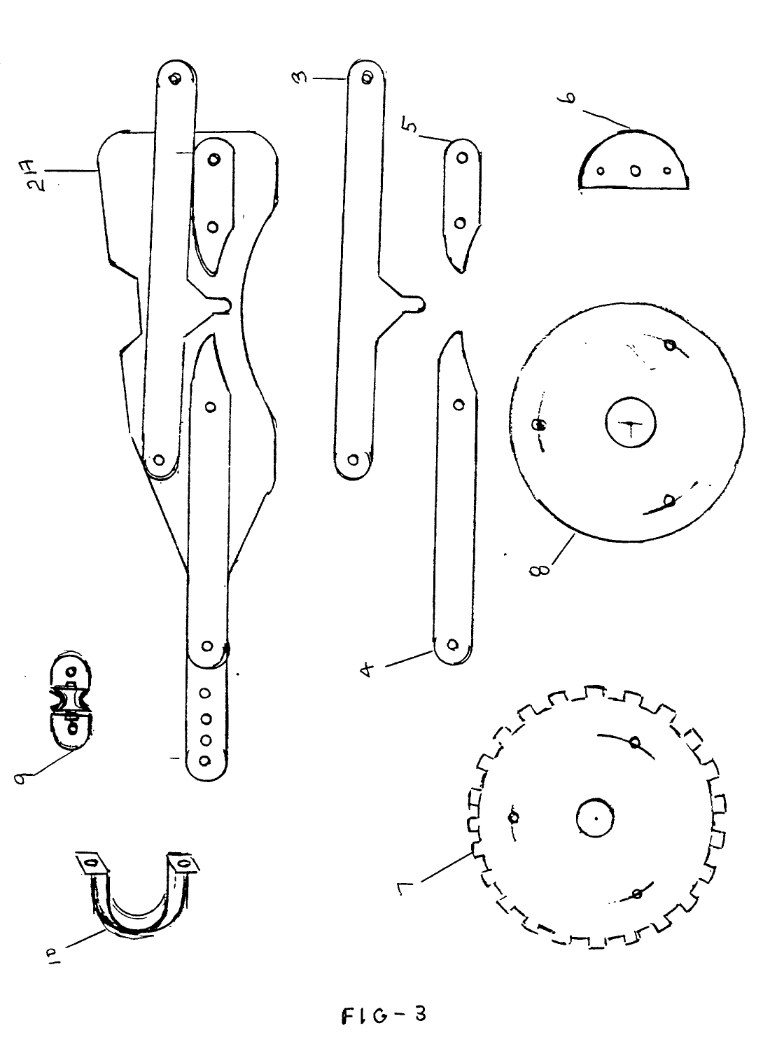

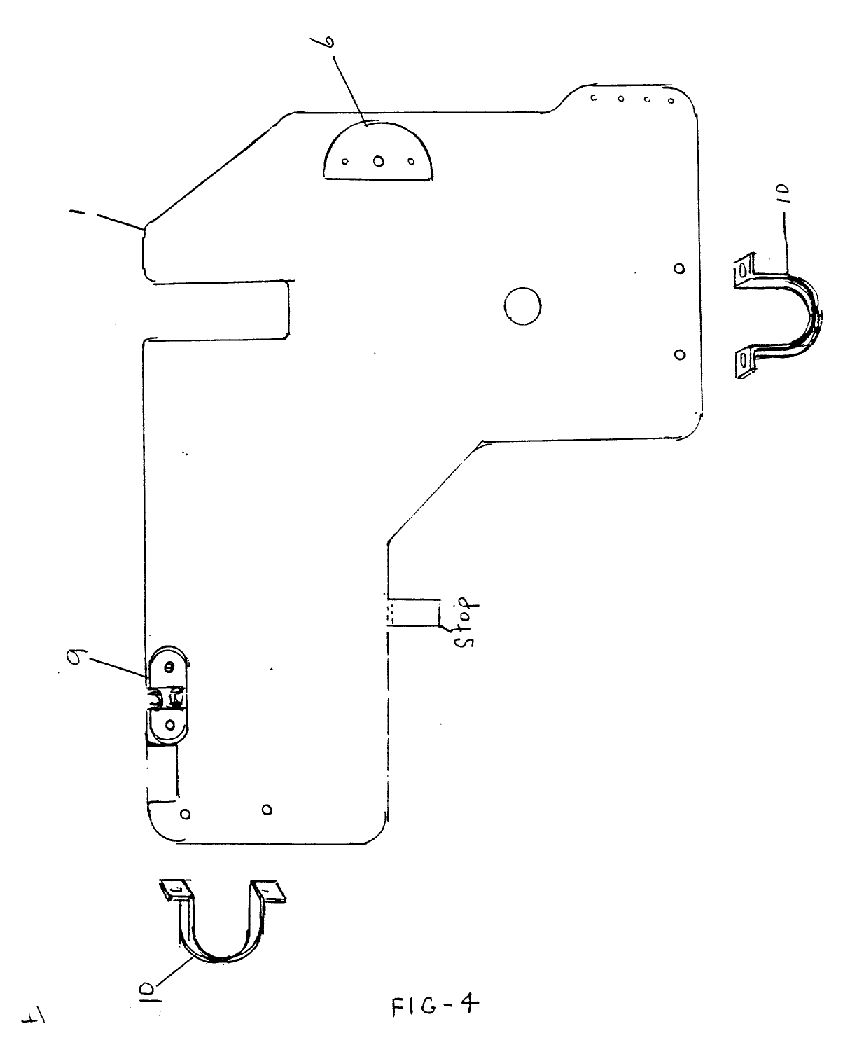

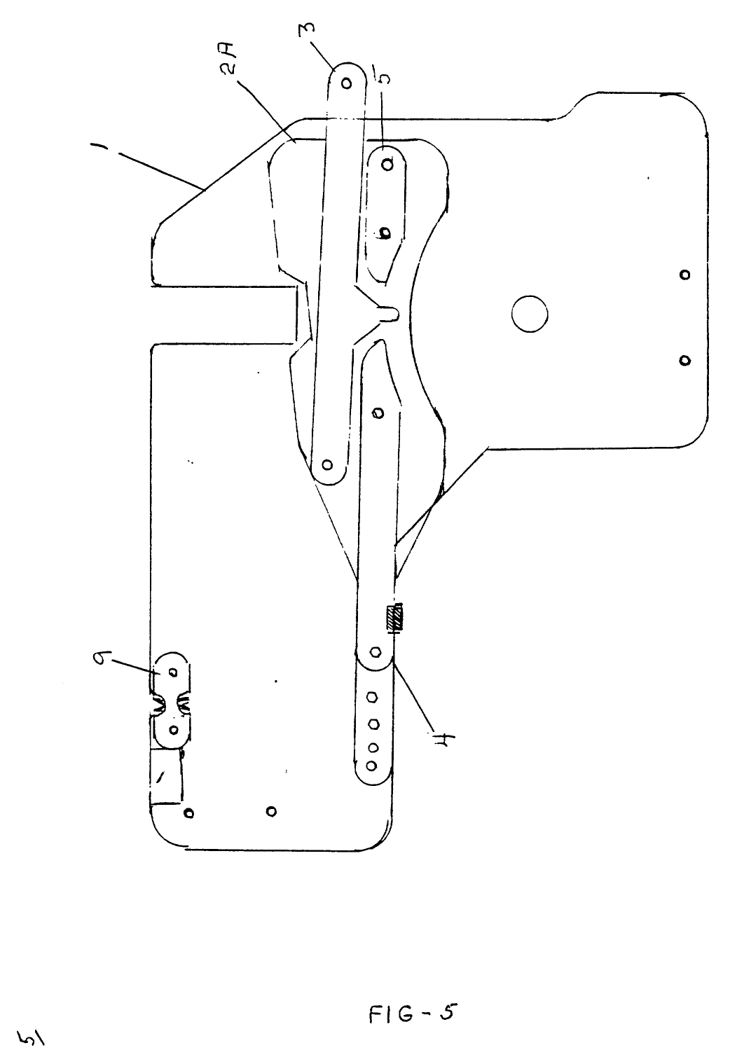

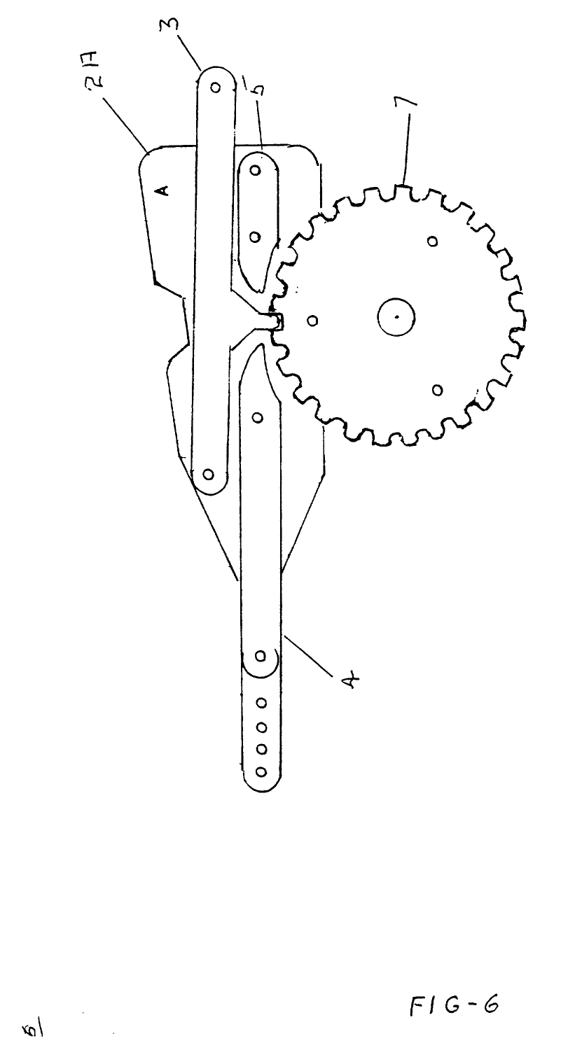

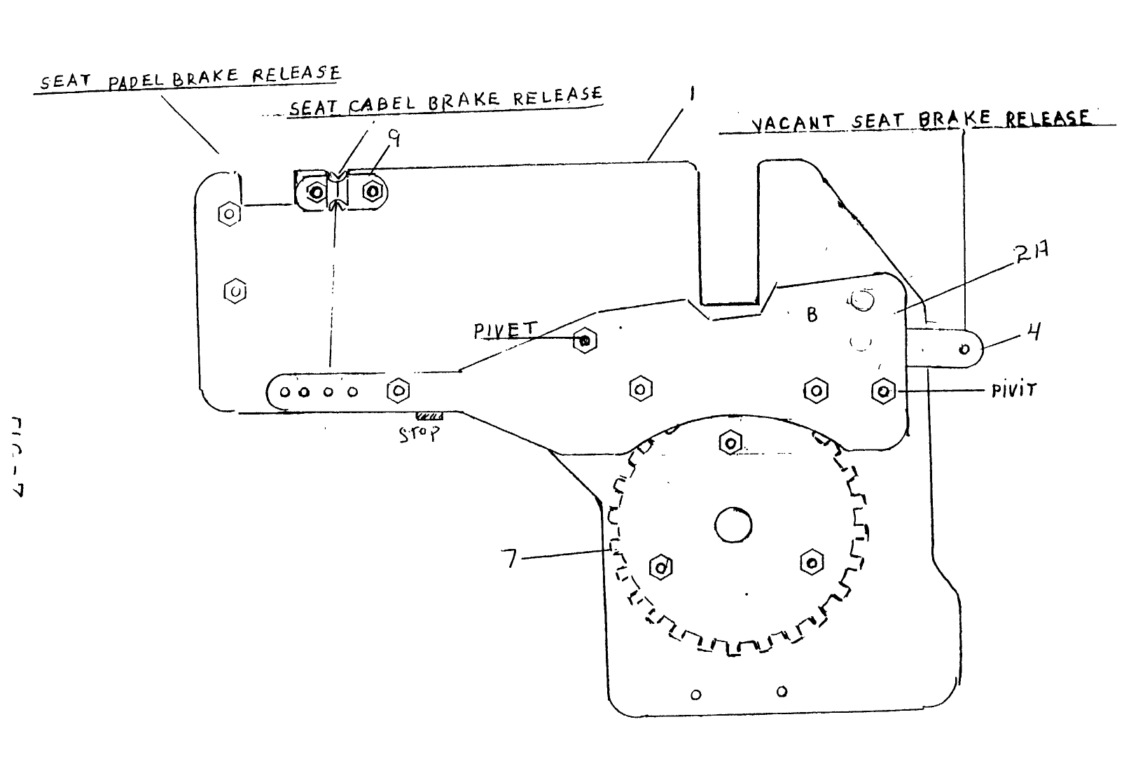

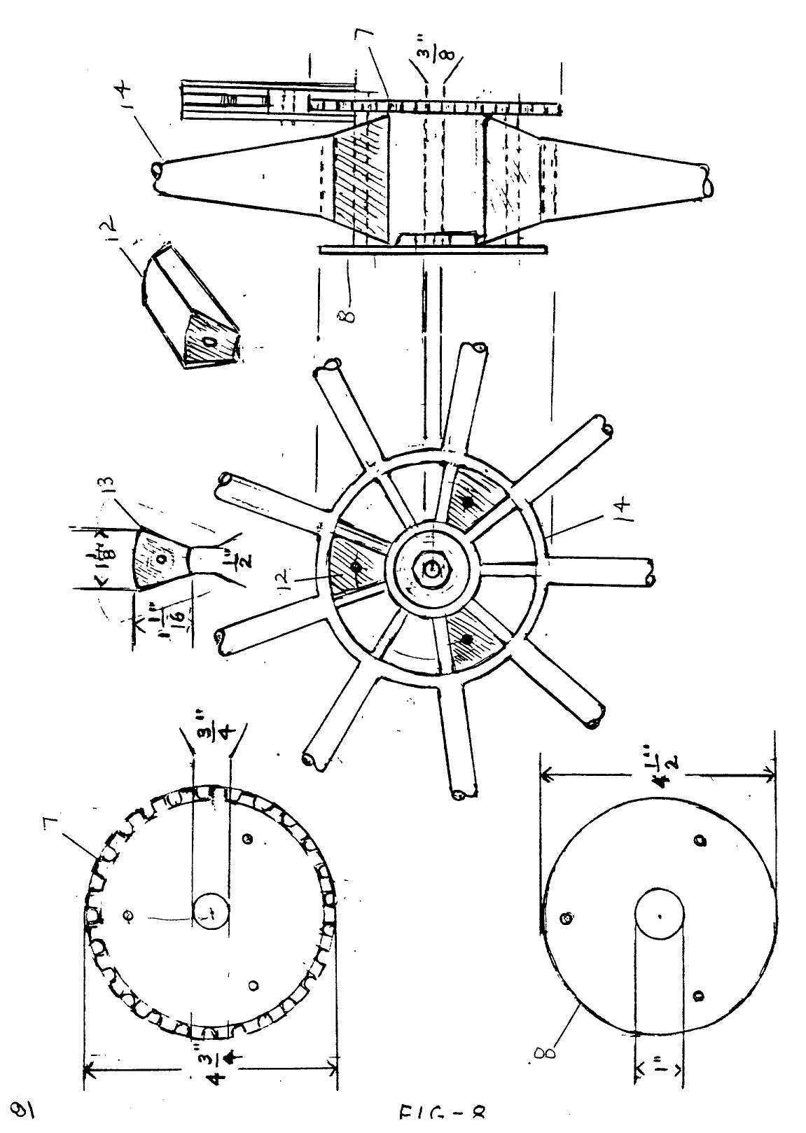

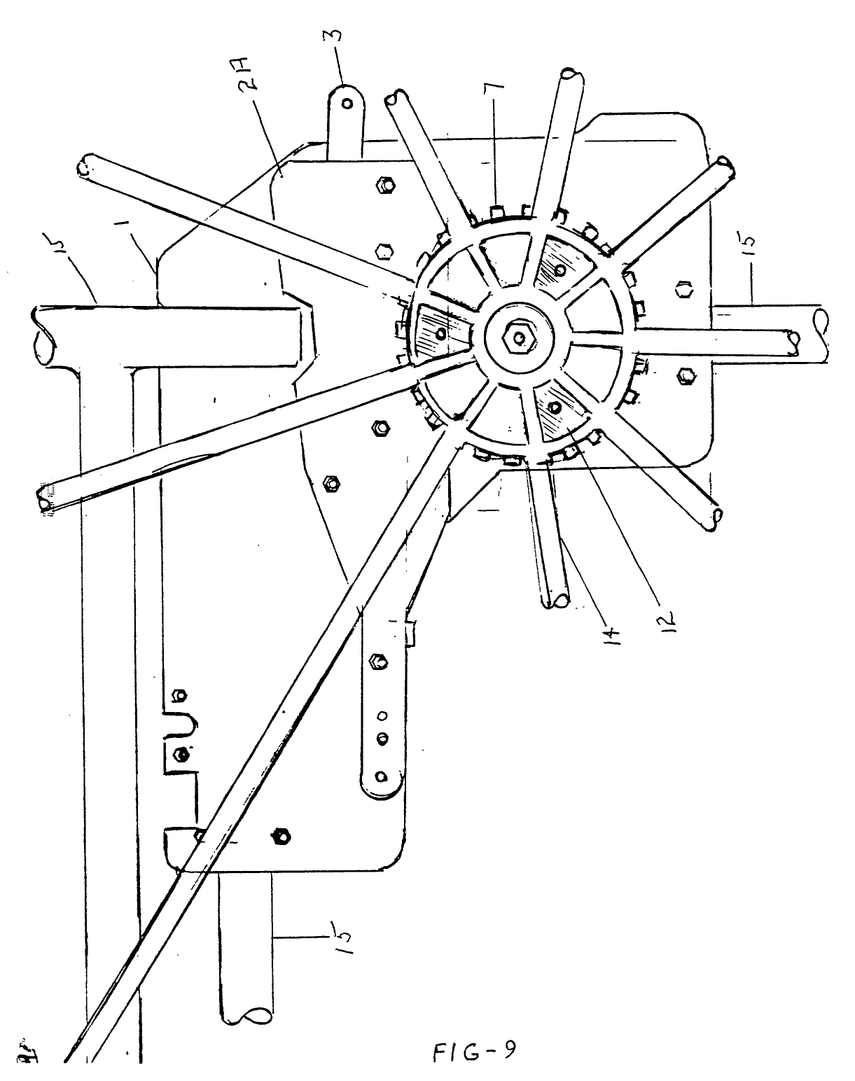

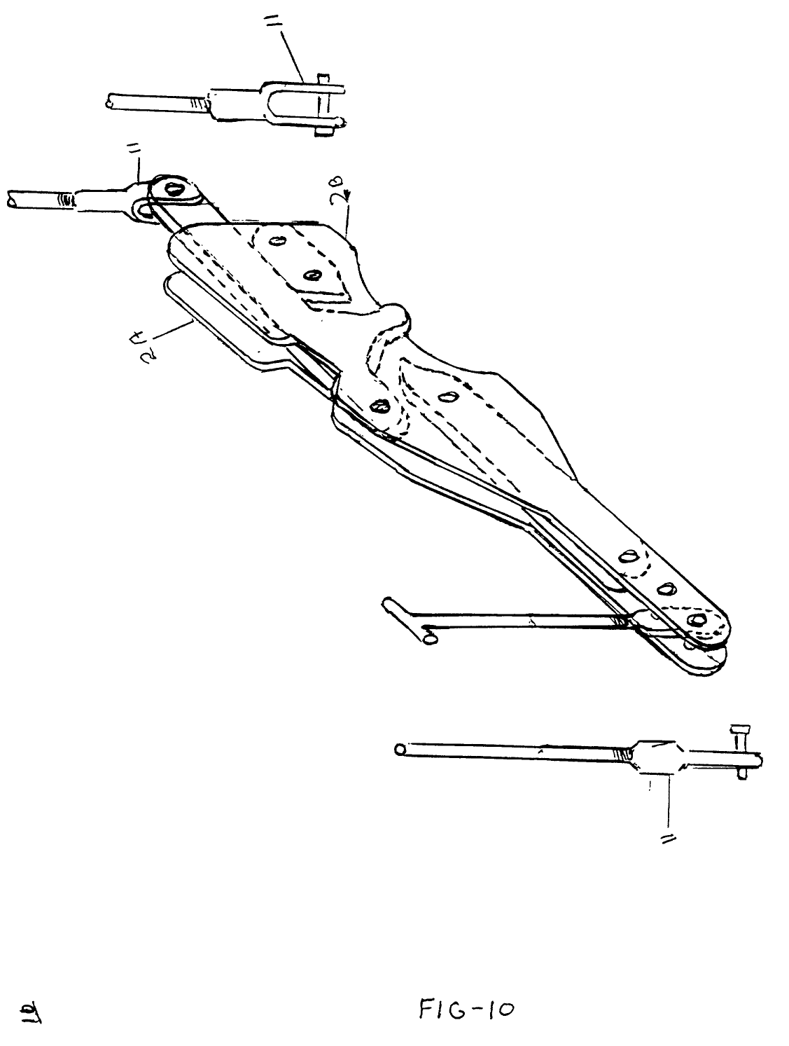

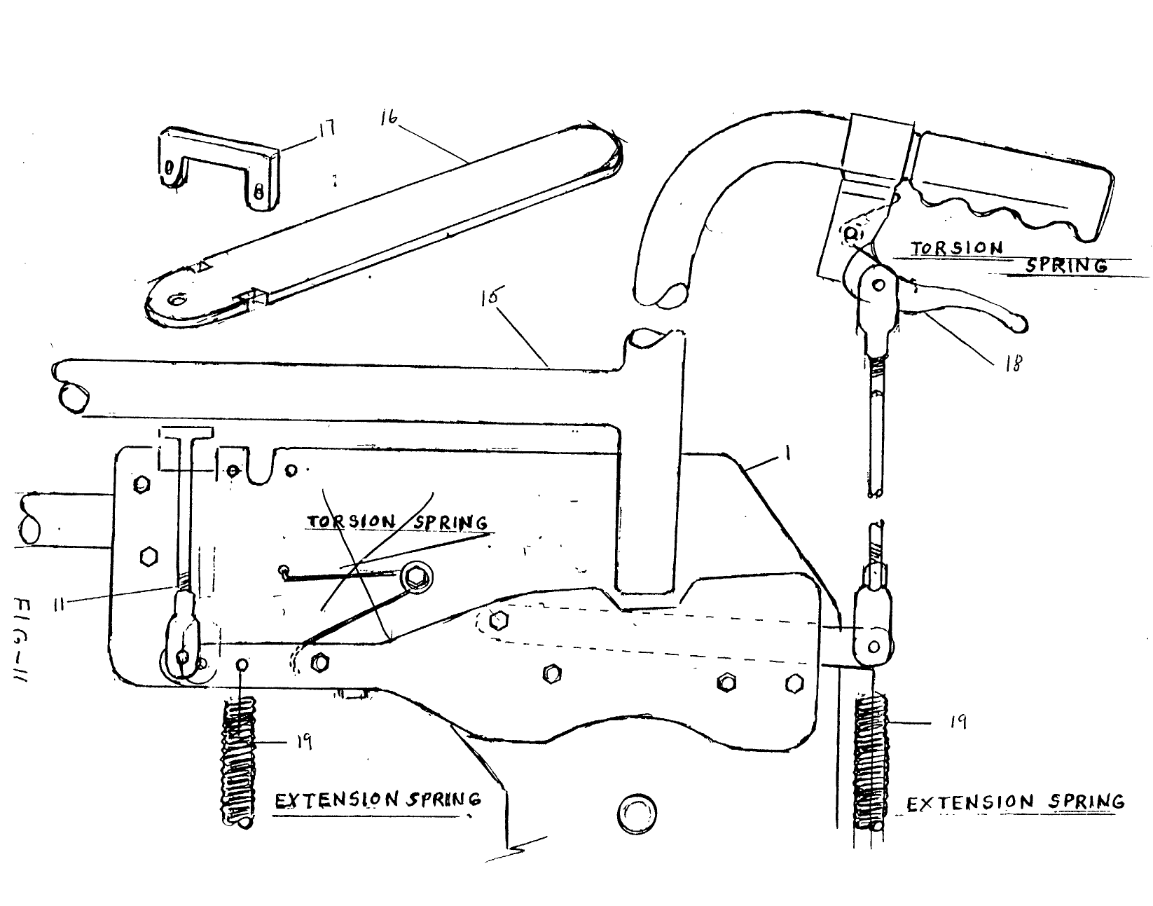

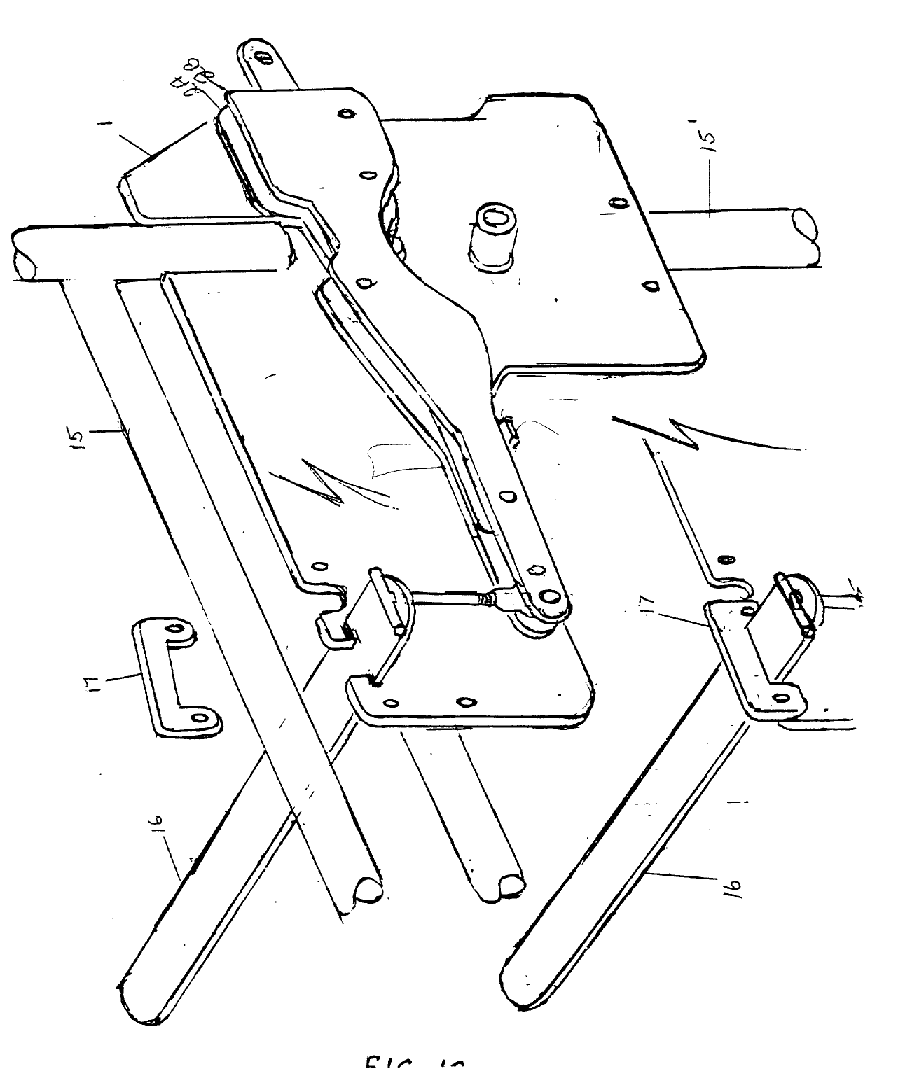

9. What prompted me to invent this automatic locking wheelchair was when my mother, who in 1994 while in a nursing home, tried to get out of her wheelchair to go to the bed and forgot to lock the wheels manually. She fell backwards as the wheelchair rolled away from her and broke her hip.

| FIG. | Page | Description |
|---|---|---|
| A. | A/13 | Overall Photos of Design Patent of Automatic Locking |
| | | Wheelchair. |
| 1 | 1/13 | Front view of the Main Plate Mechanism |
| 2 | 2/13 | A + B are Brake Arm Plates that contain Brake Parts |
| 3 | 3/13 | Front view of Mechanism Plate with pulley metal clamp |
| | | sprocket & cover plate |
| 4 | 4/13 | Overall Mechanism Plate with clamps & pulley & spacer |
| 5 | 5/13 | Orientation Drawing with Brake Parts on Mechanism |
| | | Plate |
| 6 | 6/13 | Parts attached to Plate A with sprocket |
| 7 | 7/13 | Same as FIG. 6 but mounted on Mechanism Plate with |
| | | Pivot Points and showing seat paddle & seat cable & |
| | | vacant seat break release |
| 8 | 8/13 | Wheel & Sprocket & Spacers with Cover Plate |
| 9 | 9/13 | Shows Sprocket on wheel without Cover Plate on |
| | | Mechanism Plate attached to the wheelchair |
| 10 | 10/13 | View of Locking Mechanism with T-Bolt & Clevis |
| 11 | 11/13 | Diagram showing actuating arm to handgrip & T-bar |
| | | actuator to seat paddle with extension springs or torsion |
| | | springs |
| 12 | 12/13 | Showing Paddle Seat Actuator connected to Mechanism |
| | | Plate with T-Bar |

| Item# | Nomenclature | Qty | FIG. |
|---|---|---|---|
| A. | Photos of Design Patent | 1 | A |
| 1 | Mechanism Plate 10⅝″ × 14″ | 1 | 1, 4, 5, 7, 9, 11, 12 |
| 2 | A + B are Brake Arm Plates | 1 | 2, 5, 6, 7, 9, 10, 12 |
| | They contain Brake Parts | | |
| 3 | Main Arm that is 8″ × ¾″ with a | | 3, 5, 6, 9 |
| | ¼″ extension that fits into the | | |
| | sprocket | | |
| 4 | A spacer of 6½″ × ¾″ | | 3, 5, 6, 7 |
| 5 | A spacer of 2½″ × ¾″ | | 3, 5, 6 |
| 6 | A spacer of 1¼″ × 1¾″ | | 3, 4 |
| 7 | A sprocket of 3⅞″ in diameter that | | 3, 6, 8, 9 |
| | locks on wheelchair wheel | | |
| 8 | Cover Plate attached to Hub exterior | | 3, 8 |
| 9 | Pulley for Cable under seat that | | 3, 4, 5, 7 |
| | unlocks & locks brake | | |
| 10 | V Clamp that holds Mechanism Plate | | 3, 4 |
| | 10⅝″ × 14″ to wheel chair | | |
| 11 | Levers with Pin for Push & Pull Rods | | 10, 11 |
| | on handle & seat | | |
| 12 | Plastic Plug as a filler for 3 bolts to | | 8, 9 |
| | hold Plate & Sprocket side view | | |
| 13 | End view of Plastic Filler | | 8 |
| 14 | Wheel of Wheelchair | | 8, 9 |
| 15 | 1″ tubing of wheelchair for Mecha- | | 9, 11, 12 |
| | nism Plate 10⅝″ × 14″ to attach to | | |
| 16 | Paddle Arm under seat that works | | 11, 12 |
| | Brake Release | | |
| 17 | Bracket to hold Paddle Arm in place | | 11, 12 |
| 18 | Handle for release of brake | | 11 |
| 19 | Extension Springs for locking | | 11 |
| | brake or torsion springs | | |

| Item# | Nomeclature | Dwg# |
|---|---|---|
| A | Photos of Design Patent | A |
| 1 | Main Plate | 1, 12, 14, 16, 17 |
| 2 | Brake Arm Plates | 2, 14, 15, 16, 17 |
| 3 | Main arm (fits into Sprocket) | 4, 12, 14, 15, 17 |
| 4 | Spacer KSW104 | 10, 15, 17 |
| 5 | Spacer KSW105 | 10, 15, 17 |
| 6 | Spacer KSW106 | 10, 15, 17 |
| 7 | Sprocket (locks onto wheelchair wheel) | 3, 12, 13, 14 |
| 8 | Cover Plate (attaches to wheel hub exterior) | 7, 13 |
| 9 | T-bolt | 11, 15, 16 |
| 10 | U clamp (attaches Main Plate to wheelchair | 11 |
| | tubing) | |
| 11 | Lever with pin (attaches brake arm to push | 15, 16 |
| | rod) | |
| 12 | Plastic plug | 8, 13, 14 |
| 13 | Bracket 2 | 6, 17 |
| 14 | Wheel of wheelchair | 13 |
| 15 | Tubing of wheelchair frame | 14, 16, 17 |
| 16 | Paddle Arm | 9, 16, 17 |
| 17 | Bracket (holds paddle arm in place) | 5, 16, 17 |
| 18 | Handle for brake release | 16 |
| 19 | Extension Springs for locking brake | 16 |

How the mechanism works:

A Sprocket (7) is attached to the wheel of the wheelchair. This acts as a locking device when the Main Arm (3) is allowed to drop onto it.

The Paddle arms (16) are located directly under the seat of the wheelchair. When a person sits on the seat, the paddles are depressed at the interior of the seat and lifted at the T-bolt attachment. The lifting of the T-bolt (9) causes the Brake Arm Plates (2) and Main Arm (3) to lift and releases the Main Arm from the Sprocket (7).

When the person rises from the wheelchair, the Paddle Arms (16) are pulled back up at the interior and depressed at the T-bolt due to the Extension Springs (19) attached to the Brake Arm Plates. The Brake Arm Plates (2) and Main Arm (3) then lower and lock into the Sprocket (7).

To push the wheelchair when it is empty, on applies the Handle (18) which lifts the push rod attached to the Main Arm (3), raising the Main Arm (3) out of the Sprocket (7). An Extension Spring (19) pulls the Main Arm back into the Sprocket when the Handle (18) is not applied.

| Dwg# | Description |
|---|---|
| 1 | Main Plate part drawing |
| 2 | Brake Arm Plates Part drawing |
| 3 | Sprocket part drawing |
| 4 | Main Arm part drawing |
| 5 | Bracket 1 part drawing |
| 6 | Bracket 2 part drawing |
| 7 | Cover Plate part drawing |
| 8 | Plastic Plug part drawing |
| 9 | Paddle Arms part drawing |
| 10 | Spacers part drawing |
| 11 | Hardware list |
| 12 | Orientation drawing with Brake parts located on Main Plate |
| 13 | Wheel & Sprocket Spacers with Cover Plate |
| 14 | Shows Sprocket on wheel without Cover Plate on Main Plate |
| | attached to Wheelchair |
| 15 | View of locking Mechanism with T-Bolt and push rod |
| 16 | Diagram showing actuating arm to handgrip & T-bolt to Seat |
| | Paddle Arm with extension springs. |
| 17 | Showing Paddle Arm connected to Main Plate with T-bolt. |

The following claims are set forth to cover my patent and make it different from any others-

1) It is the only wheelchair designed with an locking mechanism which automatically locks the wheelchair in place when weight is lifted off the seat without the patient having to engage mechanical handbrakes.

2) It is the only wheelchair mechanism that allows the wheelchair to be folded without first detaching support bracket manually.

3) It is especially designed so that it doesn't touch or interfere with any manual braking system on a wheelchair.

4) It is made of all hardened aluminum and stainless steel parts.

5) It locks with a specially designed metal sprocket.

6) The operation of the automatic locking mechanism does not touch rubber tires or existing mechanical brakes.

7) The unit comes preassembled which allows it to be easily attached to the wheelchair.

8) It is the only automatic locking mechanism that fits standarized wheelchairs.
